(19) United States
(12) Patent Application Publication
(10) Pub. No.: US 2026/0246597 A1
(43) Pub. Date: Aug. 20, 2026

(54) FACILITATING UPLINK OPERATIONS IN SECONDARY CELL WITHOUT SYNCHRONIZATION SIGNAL BLOCK

(71) Applicant: Nokia Technologies Oy, Espoo (FI)

(72) Inventors: Samuli Heikki TURTINEN, Ii (FI); Chunli WU, Beijing (CN); Sami-Jukka HAKOLA, Kempele (FI)

(73) Assignee: Nokia Technologies Oy, Espoo (FI)

(21) Appl. No.: 19/161,847

(22) PCT Filed: Mar. 3, 2023
(86) PCT No.: PCT/CN2023/079620

§ 371 Date: Sep. 3, 2025

(51) Int. Cl. H04L 5/00; H04B 7/26

(52) U.S. Cl. CPC H04L 5/0094; H04B 7/2612

(57) ABSTRACT

Embodiments of the present disclosure relate to devices, methods, apparatuses and computer readable storage media of facilitating uplink operation in a secondary cell (SCell) without synchronization signal block (SSB). The method comprises receiving, from a network device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and initiating a RACH to the SCell based on the received PDCCH order.

### FIELD

Embodiments of the present disclosure generally relate to the field of telecommunication and in particular to devices, methods, apparatuses and computer readable storage media of facilitating uplink operation in a secondary cell (SCell) without synchronization signal block (SSB).

### BACKGROUND

In 3rd Generation Partnership Project (3GPP) new radio (NR), the uplink operation in the SSB-less inter-band carrier aggregation (CA) scenario will be further developed.

### SUMMARY

In general, example embodiments of the present disclosure provide a solution of facilitating uplink operation in a SCell without SSB, i.e., an SSB-less SCell.

In a first aspect, there is provided an apparatus. The apparatus comprises at least one processor; and at least one memory storing instructions that, when executed by the at least one processor, cause the apparatus at least to receive, from a network device, a physical downlink control channel (PDCCH) order for a SCell without SSB, the PDCCH order at least indicating a random access channel occasion (RO) index and a random access channel (RACH) preamble index, and at least one of: a tracking reference signal (TRS) index associated with the SCell, a channel state information reference signal (CSI-RS) resource index associated with the SCell, or a SSB index associated with a quasi-co-location-ed (QCLed) serving cell of the SCell, and initiate a RACH to the SCell based on the received PDCCH order.

In a second aspect, there is provided an apparatus. The apparatus comprises at least one processor; and at least one memory storing instructions that, when executed by the at least one processor, cause the apparatus at least to transmit, to a terminal device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and receive random access information from the terminal device.

In a third aspect, there is provide a method. The method comprises receiving, from a network device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and initiating a RACH to the SCell based on the received PDCCH order.

In a fourth aspect, there is provide a method. The method comprises transmitting, to a terminal device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell and receiving random access information from the terminal device.

In a fifth aspect, there is provided an apparatus comprising means for receiving, from a network device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and means for initiating a RACH to the SCell based on the received PDCCH order.

In a sixth aspect, there is provided an apparatus comprising means for transmitting, to a terminal device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and means for receiving random access information from the terminal device.

In a seven aspect, there is provided a computer readable medium having a computer program stored thereon which, when executed by at least one processor of an apparatus, causes the apparatus to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating an example of process according to some example embodiments of the present disclosure;

FIG. 3 shows examples of the logical indices within the 160 ms period according to some example embodiments of the present disclosure;

FIG. 4 shows a flowchart of an example method of facilitating uplink operation in a SCell without SSB according to some example embodiments of the present disclosure;

FIG. 5 shows a flowchart of an example method of facilitating uplink operation in a SCell without SSB according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

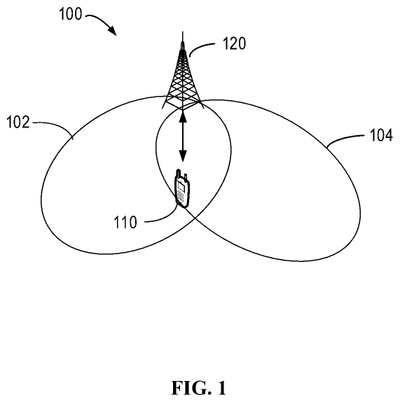

FIG. 1 shows an example communication network 100 in which embodiments of the present disclosure may be implemented. As shown in FIG. 1, the communication network 100 may include a terminal device 110. Hereinafter the terminal device 110 may also be referred to as a UE.

The communication network 100 may further include a network device 120. Hereinafter the network device 120 may also be referred to as a gNB or an eNB, respectively.

For example, the network device 120 may manage a serving cell of the terminal device 110, which may also be considered as a primary cell 102 (PCell). The network device 120 may also provide a SCell 104 for the terminal device 110. In some scenario, the SCell may also be managed by a further network device other than the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

A Physical Downlink Control Channel (PDCCH) order in 5G NR is a way of network instructing the UE to trigger a random access (RA) procedure. In general, a Random Access Channel (RACH) may be triggered by the UE and there are a number of reasons why the RACH can be triggered by UE. But the network may force the UE to trigger RACH when it detects that UE is out-of-sync in downlink, for instance. In this scenario, the network may trigger a PDCCH order by sending a DCI Format 1_0 on the SSB beam index UE is camped along with a Physical Random Access Channel (PRACH) preamble and RACH occasion (RO).

The PDCCH order is one of the reasons for RACH trigger in both LTE and 5G-NR. If the network detects that there is DL data to be sent to the UE in its Medium Access Control (MAC) buffer and there is a UL synchronization issue due to the expiry of the time alignment timer at the UE, then the network triggers a PDCCH order in order to re-synchronize with the UE.

If the UE is configured with two or more uplink secondary carriers then NR specifies that the RA procedure on an SCell may only be initiated by a PDCCH order with ra-PreambleIndex different from 0b000000 (contention free random access (CFRA)) when it is in a different Timing Advance Group (TAG) than the PCell.

If there was an ongoing RA procedure that is triggered by a PDCCH order while the UE receives another PDCCH order indicating the same RA preamble, PRACH mask index, and uplink carrier, the RA procedure is considered as the same RA procedure as the ongoing one and not initialized again.

Preamble transmission may occur within a configurable subset of RACH slots that repeats itself every RACH configuration period within a cell. Furthermore, the amount of resources for the PRACH is configurable. The resource for PRACH is set in both time and frequency. The time part may indicate how often it is occurring in UL while the frequency part may indicate how wide the resources are, in other words how many ROs are allocated in FDM manner. The RACH periodicity may be set between 10 and 160 ms and this value may indicate how often this pattern with resources is repeated (RACH slot). Within each RACH slot, there may be number of ROs which specifies how many different resources there are for each slot.

Furthermore, the possibility to establish a suitable beam pair during the initial access phase and to apply the receiver side analogue beam sweeping for the preamble reception is a key feature of 5G NR initial access and is different from LTE.

During the initial access to a cell, it is beneficial if the network device knows which beam the UE is receiving as the strongest, or strong enough. This is done by connecting a specific instance of SSB to a specific beam. The measurements are done on SSB when the UE measures on several detectable beams. Each SSB has a parameter ‘time index’ which makes it unique. By connecting an SSB time index with a specific RACH resource (RO and/or preamble), the UE may use that when accessing the cell. The network device then knows which beam the UE prefers.

Beam establishment during initial access is enabled by the possibility of associating different SSB time indices with different RACH time/frequency occasions and/or different preamble sequences. As different SSB time indices correspond to SSB transmissions in different DL beams, this means that the network, based on the received preamble, may be able to determine the DL beam in which the corresponding UE is located. This beam may then be used as an initial beam for subsequent DL transmissions to the UE.

Moreover, if the association between a SSB time index and a RO is such that a given time-domain RO corresponds to one specific SSB time index, the network device may know when, in time, preamble transmission from UEs within a specific DL beam will take place. Assuming beam correspondence, the network device may focus on the UL receiver beam in the corresponding direction for beam-formed preamble reception. This implies that the receiver beam is to be swept over the coverage area synchronized with the corresponding DL beam sweep for the SSB transmission.

The UE may be provided with a number N of SSBs that are associated with one RO and a number R of contention-based preambles mapped to each SSB. These 2 numbers (i.e., N and R) are provided to UE within RACH-ConfigCommon as ssb-perRACH-OccasionAndCB-PreamblesPerSSB. This is a 2-fold information element. First, it takes one of eight different values of N as N=⅛, ¼, ½, 1, 2, 4, 8 or 16. Consider a PRACH configuration index as 133, this index defines 6 different ROs. If the number N is set to ⅛, it means one SSB is associated with 8 consecutive ROs. Furthermore, if msg1-FDM is set to 4, the first two ROs (e.g., RO #0, RO #0). may be associated with the SSB with index #0, while the SSB Index #1 may be associated with the following two ROs (e.g., RO #2, RO #3).

In a case where in inter-band CA, an SSB-less SCell on a different band from the PCell may need to have a different TA and therefore require a configuration of a different TAG, the uplink operation in the SSB-less SCell, and more specifically in PDCCH ordered RACH is to be further discussed, because it is not clear how the UE determines the PRACH preamble and RACH occasion to be applied without indicating SSB in the PDCCH order. i.e., no reference SSB available in the downlink component carrier associated to the uplink component carrier.

Therefore, the present disclosure proposes a mechanism for facilitating uplink operation in a SCell without SSB. In this solution, the terminal device receives a PDCCH order for a SSB-less SCell, which indicates RO occasion index, RACH preamble index and at least one of a tracking reference signal (TRS) index associated with the SSB-less SCell, a channel state information reference signal (CSI-RS) resource index associated with the SSB-less SCell or a SSB index of a quasi-co-located (QCLed) serving cell of the SSB-less SCell and initiates a RACH based on the received PDCCH order.

Example embodiments of the present disclosure will be described in detail below with reference to the accompanying drawings.

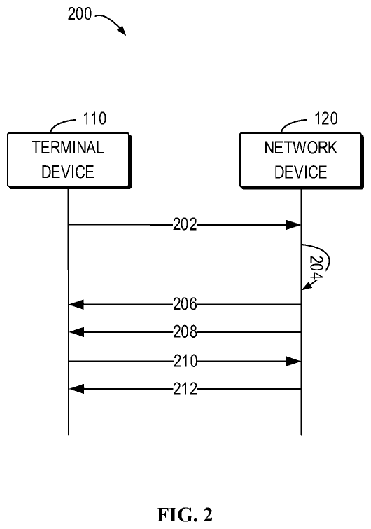

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

As an example, the network device 120 may provide a serving cell (e.g., PCell) and also an SSB-less SCell for the terminal device 110.

As shown in FIG. 2, the terminal device 110 may transmit (202), to the network device 120, an indication that the terminal device 110 has a capability to support an SSB-less SCell operation. Then the network device 120 may configure an SCell for the terminal device 110 without SSB.

In some example embodiments, the network device 120 may configure (204) a new RACH resource configuration that is not associated to any resource indices like SSB indices. The new RACH resource configuration may provide RO allocation in time and frequency domain in a certain time period, such as one or more RACH slots, e.g., within 160 resource period. The ROs may be indexed with logical indices and each RO logical index may associated with a set of PRACH preamble.

In some example embodiments, the RO logical indices may be then mapped to UL slots in frequency-division multiplexing (FDM) and/or time-division multiplexing (TDM) manner where e.g., the time domain allocation in a slot may depend on the length of the RO, i.e., on the PRACH format.

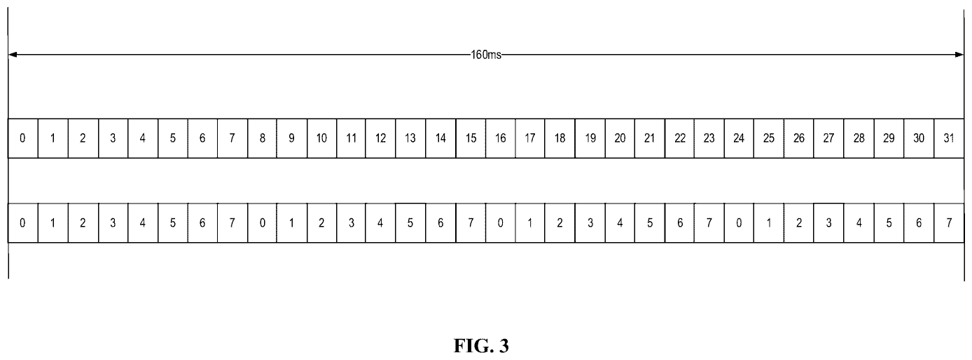

FIG. 3 shows examples of the logical indices within the 160 ms period according to some example embodiments of the present disclosure. As one example, there are 32 ROs within 160 ms period, namely RO #0 to RO #31. As another example, the ROs may be indexed with logical indices 0-7 and the RO #0 to RO #7 may occur within the 160 ms period multiple times.

The network device 120 may transmit (206) the new RACH resource configuration to the terminal device. It is to be understood that the new RACH resource configuration may also be pre-defined in the specification or pre-configured.

The network device 120 may transmit (208) to the terminal device 110, a PDCCH order for the SSB-less SCell which may trigger to terminal device 110 to initiate a RACH procedure to this SCell.

In some example embodiments, the PDCCH order may indicate a RO occasion index and a PRACH preamble index and a TRS index associated with the SSB-less SCell which may be used by the terminal device 110 for the timing reference and/or for TX beam determination.

In some other example embodiments, the PDCCH order may indicate a RO occasion index and a PRACH preamble index and a CSI-RS resource index associated with the SSB-less SCell which may be used by the terminal device 110 for the timing reference and/or for TX beam determination.

The TRS resource (index) and/or the CSI resource (index) may be periodic and/or aperiodic. As an option, the TRS or the CSI-RS may only be started to be transmitted from the SCell to the terminal device 110 when activating the SCell for the terminal device 110.

As another option, the TRS index and/or CSI-RS resource index may also be triggered when the RACH on SCell is triggered by the PDCCH order.

In some other example embodiments, the TRS index and/or CSI-RS resource index provided PDCCH order may have an SSB index of the serving cell (e.g., PCell) as the reference in QCL and/or timing sense. In this case, a separate indication indicating whether the SSB index of this serving cell is to be used by the terminal device 110 may be provided to the terminal device 110.

In some example embodiments, a PRACH configuration for an SCell without SSB may be based on a QCL serving cell with SSB. For example, this SSB of the QCL serving cell may be indicated in the PDCCH order. Then the terminal device 110 may perform DL synchronisation and the PDCCH order for the SCell without may be based on SSB from the QCL serving cell. The QCL serving cell with SSB may be a SpCell, e.g., a PCell or a primary secondary cell (PSCell).

Based on the received PDCCH order, the terminal device 110 may initiate a RACH to the SCell, for example, the terminal device 110 may transmit (210) the PRACH preamble, which is indicated in the PDCCH order, to the network device 120.

Then the network device 120 may receive PRACH preamble on the SCell and transmit (212) a random access response (RAR) to the terminal device 110 by using at least one of TRS index associated with the SCell or CSI-RS resource index associated with the SCell or the SSB index associated with the QCLed serving cell of the PCell.

In this way, a mechanism for facilitating uplink operation in a SCell without SSB may be achieved and therefore the network energy saving may be further improved as SSB is not needed on SCell and meanwhile different TAG for an SSB-less SCell may be supported.

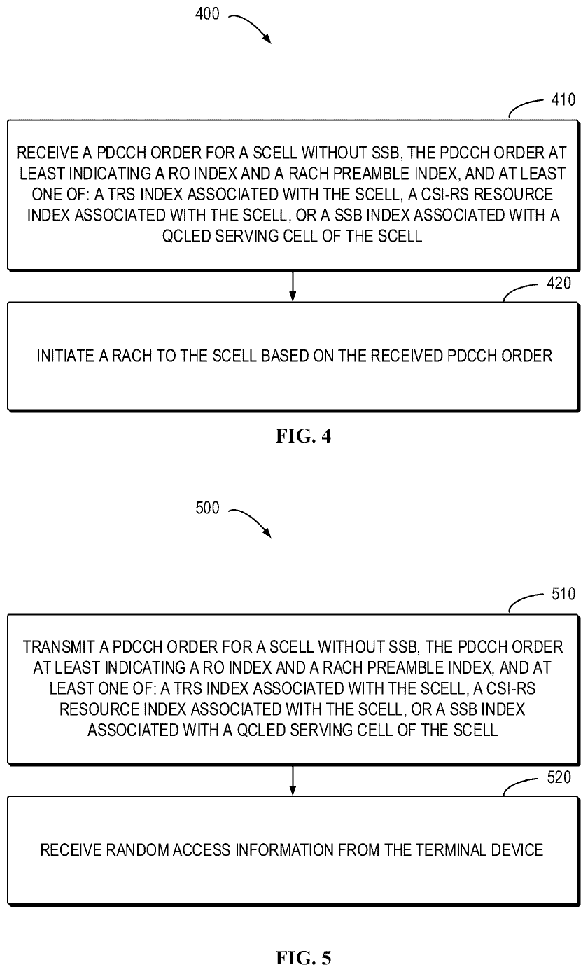

FIG. 4 shows a flowchart of an example method 400 of facilitating uplink operation in a SCell without SSB according to some example embodiments of the present disclosure. The method 400 may be implemented at the terminal device 110 as shown in FIG. 1. For the purpose of discussion, the method 400 will be described with reference to FIG. 1.

At 410, the terminal device 110 receives, from a network device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell.

At 420, the terminal device 110 initiates a RACH to the SCell based on the received PDCCH order.

In some example embodiments, the TRS index or the CSI-RS resource index is to be used for at least one of a timing reference or a transmit beam determination.

In some example embodiments, the terminal device 110 may obtain, from the network device, a RACH resource configuration indicating a RO allocation in time and frequency domain within a time period, wherein each RO index is associated with a set of RACH preambles.

In some example embodiments, the time period comprises one or more RACH slots.

In some example embodiments, a pattern for mapping RO indices to one or more uplink slots is based on a length of RO.

In some example embodiments, the PDCCH order indicating the TRS index or the CSI-RS resource index has an SSB index of a serving cell of the apparatus as the reference in QCL and/or a timing sense.

In some example embodiments, the terminal device 110 may receive, from the network device, an indication indicative whether the SSB index is to be used.

In some example embodiments, a TRS or a CSI-RS associated with the SCell is started to be transmitted from a network device to the apparatus only when the SCell is activated for the apparatus.

In some example embodiments, the TRS index or the CSI-RS resource index is triggered by the PDCCH order.

In some example embodiments, the terminal device 110 may transmit, to the network device, an indication of a capability that a SCell operation without SSB on the SCell is supported by the apparatus.

In some example embodiments, the terminal device 110 may receive, from the network device, a random access response based on at least one of the TRS index associated with the SCell, the CSI-RS resource index associated with the SCell, or the SSB index associated with the QCLed serving cell of the SCell.

FIG. 5 shows a flowchart of an example method 500 of facilitating uplink operation in a SCell without SSB according to some example embodiments of the present disclosure. The method 500 may be implemented at the network device 120 as shown in FIG. 1. For the purpose of discussion, the method 500 will be described with reference to FIG. 1.

At 510, the network device 120 transmits, to a terminal device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell.

At 520, the network device 120 receives random access information from the terminal device 110.

In some example embodiments, the network device may transmit, to the terminal device, a RACH resource configuration indicating a RO allocation in time and frequency domain within a time period, wherein each RO index is associate with a set of RACH preambles.

In some example embodiments, the time period comprises one or more RACH slots.

In some example embodiments, a pattern for mapping RO indices to one or more uplink slots is based on a length of RO.

In some example embodiments, the PDCCH order indicating the TRS index or the CSI-RS resource index has an SSB index of a serving cell of the apparatus as the reference in QCL and/or a timing sense.

In some example embodiments, the network device may transmit, to the terminal device, an indication indicative whether the SSB index is to be used.

In some example embodiments, the network device may activate the SCell for the terminal device; and transmit a TRS or a CSI-RS associated with the SCell to the terminal device.

In some example embodiments, the network device may cause the TRS index or the CSI-RS resource index to be triggered when the PDCCH order is transmitted.

In some example embodiments, the network device may receive, from the terminal device, an indication of a capability that a SCell operation without SSB on the SCell is supported by the terminal device.

In some example embodiments, the network device may transmit, to the terminal device, a random access response by using at least one of: the TRS index associated with the SCell, the CSI-RS resource index associated with the SCell, or the SSB index associated with the QCLed serving cell of the SCell.

In some example embodiments, an apparatus capable of performing the method 400 (for example, implemented at the terminal device 110) may include means for performing the respective steps of the method 400. The means may be implemented in any suitable form. For example, the means may be implemented in a circuitry or software module.

In some example embodiments, the apparatus comprises means for receiving, from a network device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and means for initiating a RACH to the SCell based on the received PDCCH order.

In some example embodiments, the TRS index or the CSI-RS resource index is to be used for at least one of a timing reference or a transmit beam determination.

In some example embodiments, the apparatus may further comprise means for obtaining, from the network device, a RACH resource configuration indicating a RO allocation in time and frequency domain within a time period, wherein each RO index is associated with a set of RACH preambles.

In some example embodiments, the time period comprises one or more RACH slots.

In some example embodiments, a pattern for mapping RO indices to one or more uplink slots is based on a length of RO.

In some example embodiments, the PDCCH order indicating the TRS index or the CSI-RS resource index has an SSB index of a serving cell of the apparatus as the reference in QCL and/or a timing sense.

In some example embodiments, the apparatus may further comprise means for receiving, from the network device, an indication indicative whether the SSB index is to be used.

In some example embodiments, a TRS or a CSI-RS associated with the SCell is started to be transmitted from a network device to the apparatus only when the SCell is activated for the apparatus.

In some example embodiments, the TRS index or the CSI-RS resource index is triggered by the PDCCH order.

In some example embodiments, the apparatus may further comprise means for transmitting, to the network device, an indication of a capability that a SCell operation without SSB on the SCell is supported by the apparatus.

In some example embodiments, the apparatus may further comprise means for receiving, from the network device, a random access response based on at least one of the TRS index associated with the SCell, the CSI-RS resource index associated with the SCell, or the SSB index associated with the QCLed serving cell of the SCell.

In some example embodiments, an apparatus capable of performing the method 500 (for example, implemented at the network device 120) may include means for performing the respective steps of the method 500. The means may be implemented in any suitable form. For example, the means may be implemented in a circuitry or software module.

In some example embodiments, the apparatus comprises means for transmitting, to a terminal device, a PDCCH order for a SCell without SSB, the PDCCH order at least indicating a RO index and a RACH preamble index, and at least one of: a TRS index associated with the SCell, a CSI-RS resource index associated with the SCell, or a SSB index associated with a QCLed serving cell of the SCell, and means for receiving random access information from the terminal device.

In some example embodiments, the apparatus may further comprise means for transmitting, to the terminal device, a RACH resource configuration indicating a RO allocation in time and frequency domain within a time period, wherein each RO index is associate with a set of RACH preambles.

In some example embodiments, the time period comprises one or more RACH slots.

In some example embodiments, a pattern for mapping RO indices to one or more uplink slots is based on a length of RO.

In some example embodiments, the PDCCH order indicating the TRS index or the CSI-RS resource index has an SSB index of a serving cell of the apparatus as the reference in QCL and/or a timing sense.

In some example embodiments, the apparatus may further comprise means for transmitting, to the terminal device, an indication indicative whether the SSB index is to be used.

In some example embodiments, the apparatus may further comprise means for activating the SCell for the terminal device; and means for transmitting a TRS or a CSI-RS associated with the SCell to the terminal device.

In some example embodiments, the apparatus may further comprise means for causing the TRS index or the CSI-RS resource index to be triggered when the PDCCH order is transmitted.

In some example embodiments, the apparatus may further comprise means for receiving, from the terminal device, an indication of a capability that a SCell operation without SSB on the SCell is supported by the terminal device.

In some example embodiments, the apparatus may further comprise means for transmitting, to the terminal device, a random access response by using at least one of: the TRS index associated with the SCell, the CSI-RS resource index associated with the SCell, or the SSB index associated with the QCLed serving cell of the SCell.

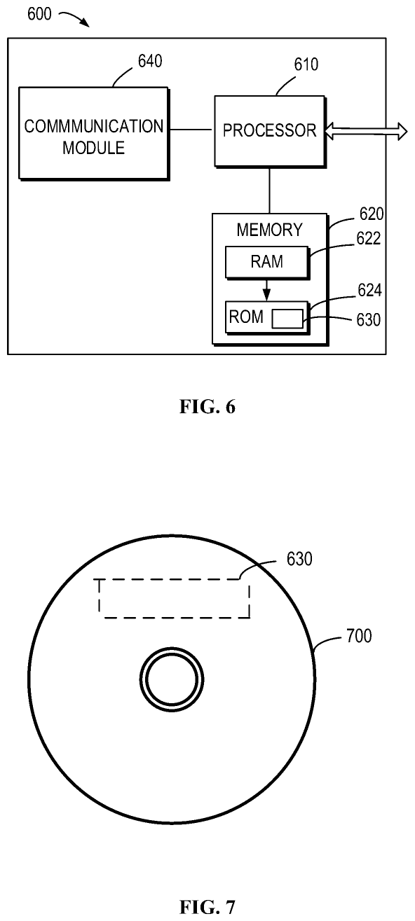

FIG. 6 is a simplified block diagram of a device 600 that is suitable for implementing example embodiments of the present disclosure. The device 600 may be provided to implement a communication device, for example, the terminal device 110 or the network device 120 or 120-2 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, from a network device, a physical downlink control channel, PDCCH, order for a secondary cell, SCell, without a synchronization signal block, SSB, the PDCCH order at least indicating a random access channel occasion, RO, index and a random access channel, RACH, preamble index, and at least one of:
a tracking reference signal, TRS, index associated with the SCell,
a channel state information reference signal, CSI-RS, resource index associated with the SCell, or
a SSB index associated with a quasi-co-location-ed, QCLed serving cell of the SCell,
initiate a RACH to the SCell based on the received PDCCH order.

2. The apparatus of claim 1, wherein the TRS index or the CSI-RS resource index is to be used for at least one of a timing reference or a transmit beam determination.

3. The apparatus of claim 1, wherein the apparatus is caused to:
obtain, from the network device, a RACH resource configuration indicating a RO allocation in time and frequency domain within a time period, wherein each RO index is associated with a set of RACH preambles.

4. The apparatus of claim 3, wherein the time period comprises one or more RACH slots.

5. The apparatus of claim 3, wherein a pattern for mapping RO indices to one or more uplink slots is based on a length of RO.

6. The apparatus of claim 1, wherein the PDCCH order indicating the TRS index or the CSI-RS resource index have an SSB index of a serving cell of the apparatus as the reference in at least one of:
a quasi-co-location, QCL, or
a timing sense.

7. The apparatus of claim 6, wherein the apparatus is caused to:
receive, from the network device, an indication indicative whether the SSB index is to be used.

8. The apparatus of claim 1, wherein a TRS or a CSI-RS associated with the SCell is started to be transmitted from a network device to the apparatus only when the SCell is activated for the apparatus.

9. The apparatus of claim 1, wherein the TRS index or the CSI-RS resource index is triggered by the PDCCH order.

10. The apparatus claim 1, wherein the apparatus is caused to:
transmit, to the network device, an indication of a capability that a SCell operation without SSB on the SCell is supported by the apparatus.

11. The apparatus of claim 1, wherein the apparatus is caused to:
receive, from the network device, a random access response based on at least one of:
the TRS index associated with the SCell,
the CSI-RS resource index associated with the SCell, or
the SSB index associated with the QCLed serving cell of the SCell.

12. An apparatus comprising:
at least one processor; and
at least one memory storing instructions that, when executed by the at least one processor, cause the apparatus at least to:
transmit, to a terminal device, a physical downlink control channel, PDCCH, order for a secondary cell, SCell, without a synchronization signal block, SSB, the PDCCH order at least indicating a random access channel occasion, RO, index and a random access channel, RACH, preamble index, and at least one of:
a tracking reference signal, TRS, index associated with the SCell,
a channel state information reference signal, CSI-RS, resource index associated with the SCell, or
a SSB index associated with a quasi-co-location-ed, QCLed serving cell of the SCell; and
receive random access information from the terminal device.

13. The apparatus of claim 12, wherein the apparatus is caused to:
transmit, to the terminal device, a RACH resource configuration indicating a RO allocation in time and frequency domain within a time period, wherein each RO index is associated with a set of RACH preambles.

14-15. (canceled)

16. The apparatus of claim 12, wherein the PDCCH order indicating the TRS index or the CSI-RS resource index have an SSB index of a serving cell of the apparatus as the reference in at least one of:
a quasi-co-location, QCL, or
a timing sense.

17. The apparatus of claim 16, wherein the apparatus is caused to:
transmit, to the terminal device, an indication indicative whether the SSB index is to be used.

18. The apparatus of claim 12,
wherein the apparatus is caused to:
activate the SCell for the terminal device; and
transmit a TRS or a CSI-RS associated with the SCell to the terminal device.

19. The apparatus of-any claim 12, wherein the apparatus is caused to:
cause the TRS index or the CSI-RS resource index to be triggered when the PDCCH order is transmitted.

20. The apparatus of claim 12, wherein the apparatus is caused to:
receive, from the terminal device, an indication of a capability that a SCell operation without SSB on the SCell is supported by the terminal device.

21. The apparatus of claim 12, wherein the apparatus is caused to:
transmit, to the terminal device, a random access response by using at least one of:
the TRS index associated with the SCell,
the CSI-RS resource index associated with the SCell, or
the SSB index associated with the QCLed serving cell of the SCell.

22. A method comprising:
receiving, from a network device, a physical downlink control channel, PDCCH, order for a secondary cell, SCell, without a synchronization signal block, SSB, the PDCCH order at least indicating a random access channel occasion, RO, index and a random access channel, RACH, preamble index, and at least one of:
a tracking reference signal, TRS, index associated with the SCell,
a channel state information reference signal, CSI-RS, resource index associated with the SCell, or
a SSB index associated with a quasi-co-location-ed, QCLed serving cell of the SCell,
initiating a RACH to the SCell based on the received PDCCH order.

23-26. (canceled)
